(19) United States
(12) Patent Application Publication
(10) Pub. No.: US 2002/0040553 A1
(43) Pub. Date: Apr. 11, 2002

(54) Pulley for double hung windows

(76) Inventor: Gary Evans, Burradoo (AU)

Correspondence Address: COLLEN LAW ASSOCIATES, P.C., COUNSELORS AT LAW, The Holyoke Manhattan Building, 80 SOUTH HIGHLAND AVENUE, OSSINING, NY, 10562, US

(21) Appl. No.: 09/925,364

(22) Filed: Aug. 9, 2001

(30) Foreign Application Priority Data
Oct. 8, 2000 (AU) PQ 9332

(51) Int. Cl. E05F 1/00

(52) U.S. Cl. 49/445

(57) ABSTRACT

The invention proposes a pulley apparatus (27) for use with double hung vertical sash windows. The apparatus (27) comprises a base (32) which supports a pair of pulleys (42). One or both pullies (42) may be adjustable. The apparatus (27) is adapted to be installed into a recess in a window head (20) so that it is flush with the head (20).

### TECHNICAL FIELD

The invention pertains to double hung windows and also to a pulley system for counterbalancing, in a double hung window, one sash with the other sash.

### BACKGROUND ART

A window sash consists of a window pane which is surrounded by a frame. A double hung window consists of an arrangement of two sashes, each of which may travel vertically in one of two pair of adjacent parallel grooves formed in the vertical stiles which abut or form a portion of the window's jamb. Various mechanisms are known whereby springs or counterweights are used to offset the effort required to raise a sash or correspondingly, to prevent the sash from falling under its own weight. Known methods of accomplishing this are considered complicated or expensive and many known methods are not suitable for retrofitting to existing windows.

According to one aspect of the invention there is provided a pulley apparatus for a double hung window comprising:

a base which supports a pair of pulleys each having an axle;

the base having a pair of ears which extend away from the pullies;

the base having a pair of cord openings each cord opening in registry with an outer extremity of a pulley so that the axles are between the openings.

### BRIEF DESCRIPTION OF THE DRAWINGS

FIG. 1 is a front elevation of a double hung window,

FIG. 2 is a cross-sectional view through lines A-A of FIG. 1,

FIG. 3 is a cross-section of a sash and window head according to one embodiment of the present invention,

FIG. 4 is a top plan view of a pulley according to one embodiment of the invention,

FIG. 5 is a cross-sectional view of the pulley depicted in FIG. 4, taken through lines A-A of FIG. 4, and

FIG. 6 is an end elevation of the pulley depicted in FIG. 5.

### MODES FOR CARRYING OUT THE INVENTION

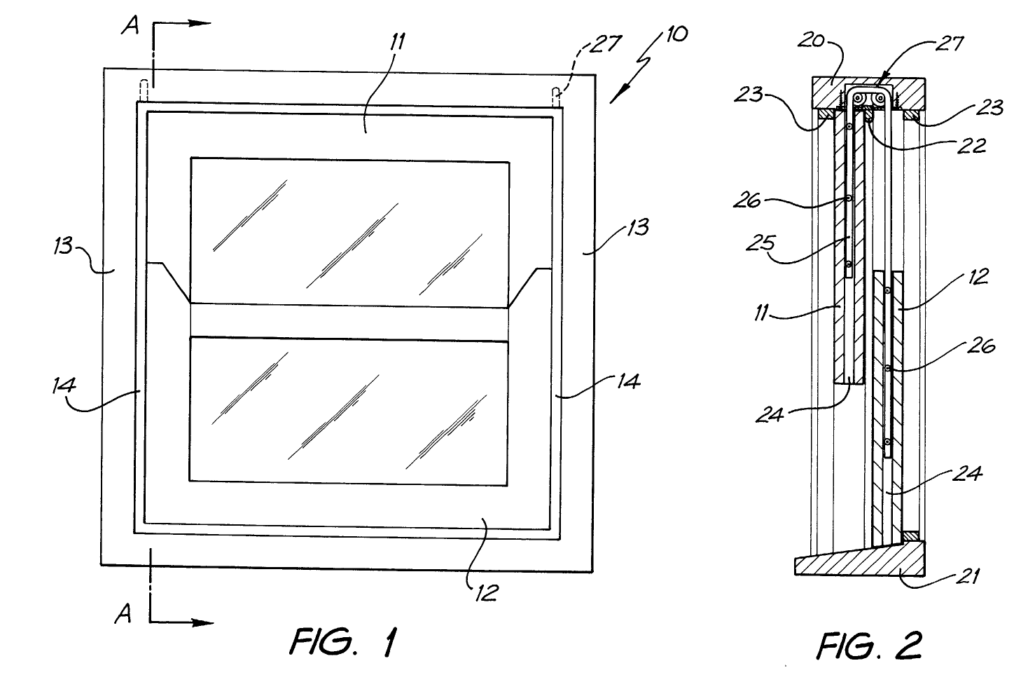

FIG. 1 illustrates a double hung window 10. The window comprises upper and lower sashes 11, 12. The window frame includes vertical jambs 13. Each jamb 13 includes or is joined to a stile 14. Each stile 14 includes a pair of adjacent and parallel vertical tracks.

As shown in FIG. 2, the window further comprises a head 20 and a sill 21. The full length vertical grooves in the stile 14 are defined by the central parting bead 22 and the pair of stop beads 23. These tracks guide the sashes in their vertical movement.

As further shown in FIG. 2, the pair of sashes 11, 12 are counterbalanced against one another. The vertical side edge of each sash 11, 12 is provided with a recess or groove 24. The groove 24 is sized to receive a sash cord 25 which is affixed by screws 26 or otherwise into the groove 24 and against the sash. A length of sash cord (equal to about half the length of the sash) is affixed in each groove 24.

In order that one sash counterbalances the other, a pulley device 27 is recessed into the window head 20 above each of the stiles 14. Each of the two sash cords 25 passes over a pulley device 27.

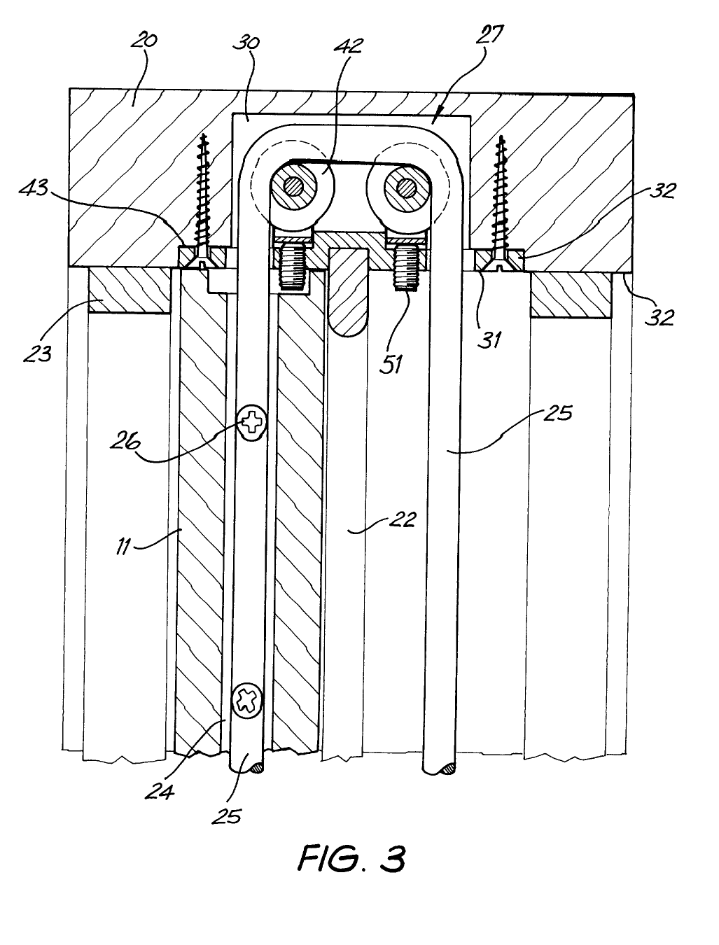

As shown in FIG. 3, the pulley device 27 is located within a recess 30 formed within the window head 20. The outer or lower flat surface 31 of the pulley device 27 is generally flush with the lower surface 32 of the window head 20. The pulley device 27 comprises a base 32 which supports a pair of parallel side plates 33. As shown in FIG. 4, two pairs of opposing slots 35, 36 are formed into the interior facing surfaces of each side plate 33. Each of the pairs of slots 35, 36 receives a “U” shaped yoke 40, the yoke 40 supporting an axle 41 about which a pulley 42 rotates.

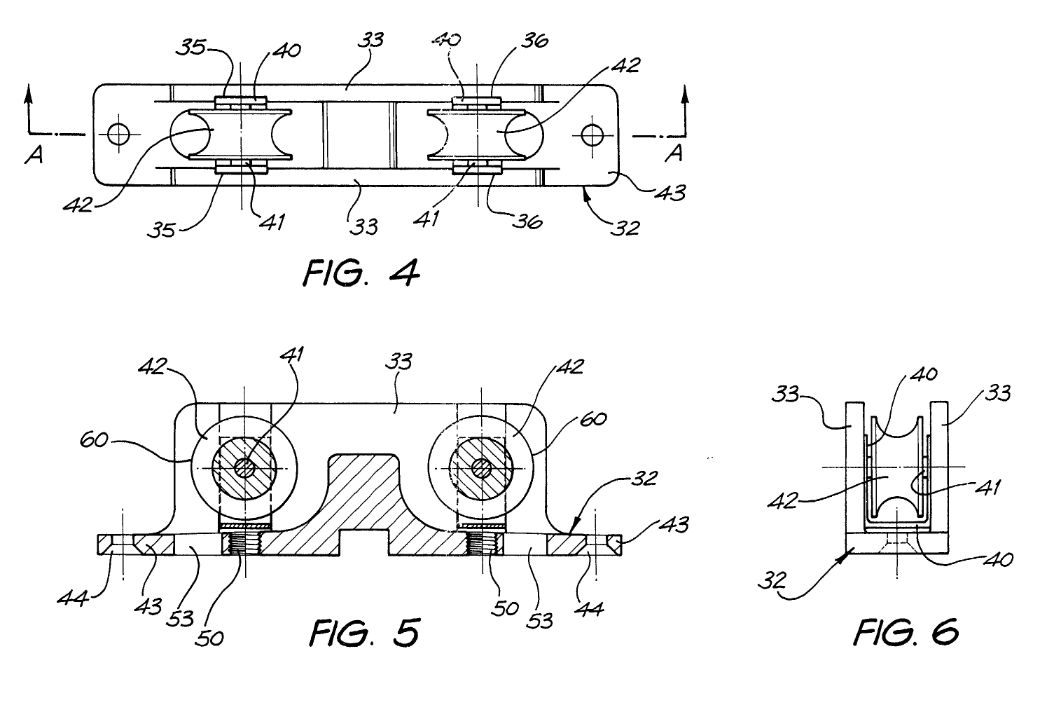

As shown in FIGS. 4 to 6, the base 32 includes ears 43 which extend away from the pullies and the underside of each ear 43 includes a through hole 44 which is preferably countersunk to permit the pulley device 27 to be mounted flush using a pan headed screw or the like with the lower surface 32 of the window head 20. The base 32 also incorporates a pair of openings 53 which allow the cord to pass around the pair of pulleys 42. The opening are in registry with an outer extremity 60 of a pulley, so that the axles 41 of both pullies are located between the openings 53.

One or both of the pulleys 42 may be made vertically adjustable by providing a vertical through opening 50 in the base 32 below the yoke 40. The threaded vertical opening 50 receives a threaded member, bolt or screw 51 which may be used to raise (or lower) the effective height of the yoke, axle and pulley above the base 32. IN the alternative, both pullies may be mounted in a common yoke for simultaneous adjustment. In this way, any slack in the sash cord 25 caused by stretching or ageing can be adjusted out.

It will be observed that this arrangement allows the pulleys to be mounted directly above the stile grooves and sash cord slots. The arrangement provides a suitable means of constructing new windows as well as a convenient means of retro-fitting existing double hung windows having broken or damaged counterweights or springs.

The present invention thereby provides a pulley device, a kit of parts and a method for retrofitting a window, hardware and a method for assembling a new window, and windows when fitted according to the teachings of the invention.

It will be appreciated that the above described system is a compact and efficient way of counterbalancing a sash in a window. It will be appreciated that the invention is preferably deployed in a timber window but that the invention may be extended into any window incorporating similar constructions methods, irrespective of the material in which it is constructed.

While the present invention has been described with reference to particular details of construction it should be understood as having been provided by way of example and not as limitations to the scope or spirit of the invention.

What is claimed is:

1. A pulley apparatus for a double hung window comprising:
a base which supports a pair of pulleys each having an axle;
the base having a pair of ears which extend away from the pulleys;
the base having a pair of cord openings each cord opening in registry with an outer extremity of one of the pulleys with the axles being between the openings.

2. The apparatus of claim 1, wherein:
the base further comprises a yoke, the yoke supporting one of the axles and being vertically adjustable with respect to the base.

3. The apparatus of claim 2, wherein:
the base has a pair of parallel walls, the walls having a first pair of slot formed on opposing interior surfaces, the pair of slots slidably receiving the yoke for adjustable movement.

4. The apparatus of claim 3, wherein:
the base incorporates a threaded opening below the yoke, the threaded opening receiving a threaded member which bears on the yoke and which is used to adjust the vertical position of the yoke.

5. The apparatus of claim 4, wherein:
both pulleys are mounted in a single yoke.

6. The apparatus of claim 2, wherein:
the base further comprises a second pair of slots adjacent to the first pair, the second pair of slots slidably receiving another yoke which supports the other pulley.

7. The apparatus of claim 4, wherein:
an underside of each ear has formed therein a countersunk hole.

8. In combination, a pair of pulley apparatuses according to any one of claims 1 to 7, a pair of vertical window sashes, a pair of cords attaching the sashes, each cord passing through the cord openings of a pulley apparatus and passing over the pulleys in an apparatus, so that the sashes are counterbalanced.

9. The combination of claim 8, together with a window frame having a head, the pulley apparatuses being located within a pair of recesses formed in the window head, the lower surface of the base of each pulley apparatus being flush with a lower surface of the window head.

10. The combination of claim 8, wherein:
each sash comprises a pair of vertical side edges, each edge provided with a groove for receiving a cord.
